(19) United States
(12) Patent Application Publication
(10) Pub. No.: US 2025/0377240 A1
(43) Pub. Date: Dec. 11, 2025

(54) STATE ESTIMATION APPARATUS, STATE ESTIMATION METHOD, AND NON-TRANSITORY COMPUTER READABLE MEDIUM

(71) Applicant: NEC Corporation, Tokyo (JP)

(72) Inventors: Sakiko MISHIMA, Tokyo (JP); Noriyuki TONAMI, Tokyo (JP); Reishi KONDO, Tokyo (JP); Tomoyuki HINO, Tokyo (JP)

(73) Assignee: NEC Corporation, Tokyo (JP)

(21) Appl. No.: 19/215,704

(22) Filed: May 22, 2025

(30) Foreign Application Priority Data
Jun. 5, 2024 (JP) 2024-091637

(51) Int. Cl. G01H 9/00

(52) U.S. Cl. CPC G01H 9/004

(57) ABSTRACT

A state estimation apparatus according to the present disclosure includes: at least one memory configured to store a group of commands; and at least one processor configured to execute the group of commands to calculate, for each point on a submarine cable, response characteristics to vibration applied to that point on the basis of a measurement signal obtained by a measurement apparatus by executing optical fiber sensing using an optical fiber included in the submarine cable, compare, for each point on the submarine cable, the response characteristics of that point with the response characteristics of a reference point, and obtain a result of the comparison as a first comparison result, and estimate a state of the submarine cable on the basis of the first comparison result of each point on the submarine cable.

### INCORPORATION BY REFERENCE

This application is based upon and claims the benefit of priority from Japanese patent application No. 2024-091637, filed on Jun. 5, 2024, the disclosure of which is incorporated herein in its entirety by reference.

### TECHNICAL FIELD

The present disclosure relates to a state estimation apparatus, a state estimation method, and a non-transitory computer readable medium.

### BACKGROUND ART

FIG. 1 is a diagram illustrating an example of a facility for realizing offshore wind power generation.

As illustrated in FIG. 1, in the offshore wind power generation, offshore facilities 60a and 60b such as wind turbines are provided at sea, and an onshore facility 50 such as an electric power substation is provided on land. Hereinafter, in a case where which the offshore facilities 60a and 60b are not specified, it is simply referred to as an “offshore facility 60” as appropriate. In addition, the number of the offshore facilities 60 is not limited to two, and may be one or more.

In addition, the onshore facility 50 and the offshore facility 60a and the offshore facilities 60a and 60b are connected by a submarine cable 30 including a power line and an optical fiber, power transmission is performed via the power line, and communication is performed via the optical fiber.

In addition, the submarine cable 30 is mostly buried in the seabed, and near the offshore facility 60, the submarine cable 30 is raised from the seabed and laid inside the offshore facility 60.

Meanwhile, in recent years, there is a technology for estimating a state of an optical cable by executing optical fiber sensing represented by distributed acoustic sensing (DAS) using an optical fiber. Incidentally, in the DAS, vibration and sound generated around the optical fiber are detected.

For example, Patent Literature 1 discloses a technology for determining the presence or absence of slack as the state of the optical cable. Specifically, according to the technology disclosed in Patent Literature 1, an identification function for each position of an optical cable is calculated from a vibration distribution in a longitudinal direction of the optical cable, the calculated identification function is compared with a training signal representing two states (presence or absence of slack), and the state of the training signal that is closer is determined as the state of the optical cable.

Therefore, recently, there is an increasing demand for estimating the state of the submarine cable 30 by executing optical fiber sensing using the optical fiber included in the submarine cable 30.
[Patent Literature 1] International Patent Publication No. WO 2023/119628

### SUMMARY

Meanwhile, in order to estimate the state of the submarine cable using the technology disclosed in Patent Literature 1, it is necessary to prepare in advance a training signal at time there is no abnormality such as slack and a training signal at time there is an abnormality.

However, since the frequency of occurrence of an abnormal situation in the submarine cable is low, there is a problem that it is particularly difficult to acquire abnormality data that is data at time there is an abnormality.

In this regard, in view of the above-described problems, an example object of the present disclosure is to provide a state estimation apparatus, a state estimation method, and a non-transitory computer readable medium capable of estimating a state of a submarine cable without preparing abnormality data in advance.

A state estimation apparatus according to a first example aspect includes:
at least one memory configured to store a group of commands; and
at least one processor configured to execute the group of commands to
   calculate, for each point on a submarine cable, response characteristics to vibration applied to that point on the basis of a measurement signal obtained by a measurement apparatus by executing optical fiber sensing using an optical fiber included in the submarine cable,
   compare, for each point on the submarine cable, the response characteristics of that point with the response characteristics of a reference point, and obtain a result of the comparison as a first comparison result, and
   estimate a state of the submarine cable on the basis of the first comparison result of each point on the submarine cable.

A state estimation method according to a second example aspect is a state estimation method executed by a state estimation apparatus, including:
a signal analysis step of calculating, for each point on a submarine cable, response characteristics to vibration applied to that point on the basis of a measurement signal obtained by a measurement apparatus by executing optical fiber sensing using an optical fiber included in the submarine cable;
a first comparison step of comparing, for each point on the submarine cable, the response characteristics of that point with the response characteristics of a reference point, and obtaining a result of the comparison as a first comparison result; and
a state estimation step of estimating a state of the submarine cable on the basis of the first comparison result of each point on the submarine cable.

A non-transitory computer readable medium according to a third example aspect is a non-transitory computer readable medium having stored thereon a program
causing a computer to execute:
a signal analysis procedure of calculating, for each point on a submarine cable, response characteristics to vibration applied to that point on the basis of a measurement signal obtained by a measurement apparatus by executing optical fiber sensing using an optical fiber included in the submarine cable;
a first comparison procedure of comparing, for each point on the submarine cable, the response characteristics of that point with the response characteristics of a reference point, and obtaining a result of the comparison as a first comparison result; and
a state estimation procedure of estimating a state of the submarine cable on the basis of the first comparison result of each point on the submarine cable.

According to the above-described aspect, it is possible to provide the state estimation apparatus, the state estimation method, and the non-transitory computer readable medium capable of estimating the state of the submarine cable without preparing the abnormality data in advance.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a diagram illustrating an example of a facility for realizing offshore wind power generation;

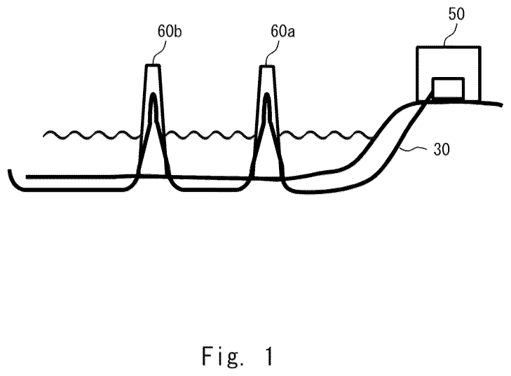

FIG. 2 is a diagram for explaining an outline of the present disclosure;

FIG. 3 is a diagram for explaining a key point of the present disclosure;

FIG. 4 is a diagram for explaining a key point of the present disclosure;

FIG. 5 is a diagram illustrating a configuration example of a state estimation system according to the present disclosure;

FIG. 6 is a flowchart for explaining an example of an operation flow of a signal analysis unit according to the present disclosure;

FIG. 7 is a flowchart for explaining an example of a processing flow in step S12 in FIG. 6;

FIG. 8 is a diagram for explaining an example of processing in steps S122 and S123 in FIG. 7;

FIG. 9 is a diagram for explaining an example of response characteristics calculated by the signal analysis unit according to the present disclosure;

FIG. 10 is a flowchart for explaining an example of an operation flow of a first comparison unit according to the present disclosure.

FIG. 11 is a flowchart for explaining an example of an operation flow of a state estimation unit according to the present disclosure;

FIG. 12 is a diagram for explaining a key point of the present disclosure;

FIG. 13 is a diagram illustrating a configuration example of the state estimation system according to the present disclosure;

FIG. 14 is a flowchart for explaining an example of the operation flow of the first comparison unit according to the present disclosure;

FIG. 15 is a flowchart for explaining an example of an operation flow of a second comparison unit according to the present disclosure; and

FIG. 16 is a block diagram illustrating a hardware configuration example of a computer that implements the state estimation apparatus according to the present disclosure.

### EXAMPLE EMBODIMENT

Hereinafter, example embodiments of the present disclosure will be described with reference to the drawings. Note that, in the following description and drawings, omission and simplification are made, as appropriate, for clarity of explanation. Furthermore, in the following drawings, the same elements are denoted by the same reference signs, and redundant description will be omitted as necessary. In addition, specific numerical values and the like shown below are merely examples for facilitating understanding of the present disclosure, and the present disclosure is not limited thereto.

### <Outline of Present Disclosure>

First, an outline of the present disclosure will be described.

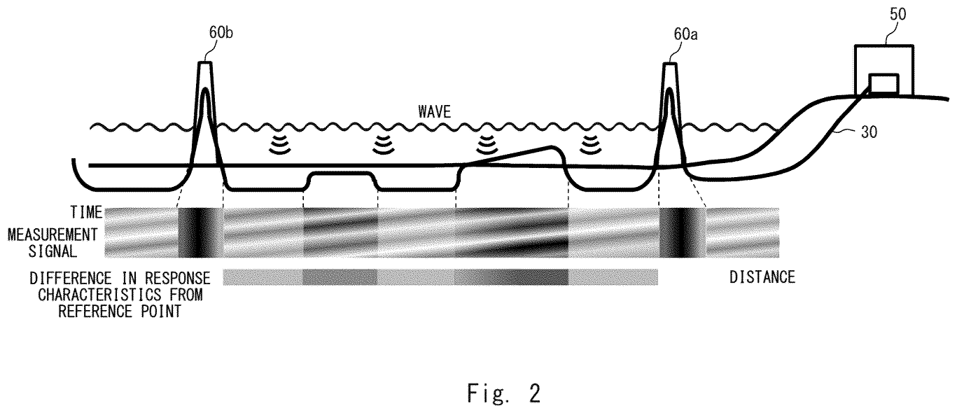

FIG. 2 is a diagram for explaining the outline of the present disclosure.

In each example embodiment of the present disclosure, a state of a submarine cable 30 is estimated by using response characteristics to vibration (background vibration) applied to the submarine cable 30. The vibration applied to the submarine cable 30 is vibration caused by a wave, and propagates continuously in time and space.

As illustrated in FIG. 2, the vibration caused by a wave is applied to each point on the submarine cable 30. Here, a measurement signal is obtained by a measurement apparatus 20 to be described later, and is a spatiotemporal signal indicating a time-series change in vibration intensity at each point on the submarine cable 30. As is apparent from the measurement signal, points having different states on the submarine cable 30 have different response characteristics to vibration. From this, the difference in response characteristics between points on the submarine cable 30 represents a difference in the state of the submarine cable 30.

Therefore, in each example embodiment of the present disclosure, the state of the submarine cable 30 is estimated using the difference in the response characteristics to vibration for each point on the submarine cable 30. As a result, it is possible to estimate the state of the submarine cable 30 without preparing in advance abnormality data at time there is an abnormality.

### First Example Embodiment

First, a key point of a first example embodiment will be described.

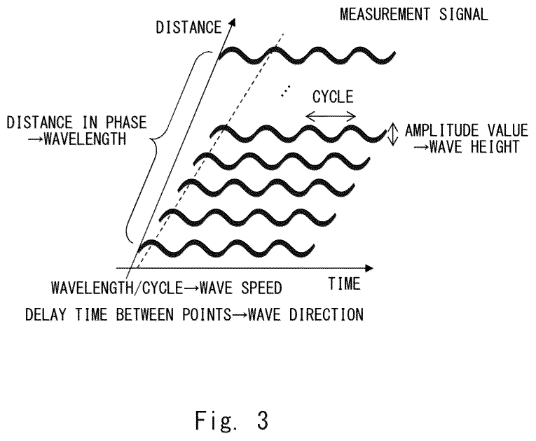

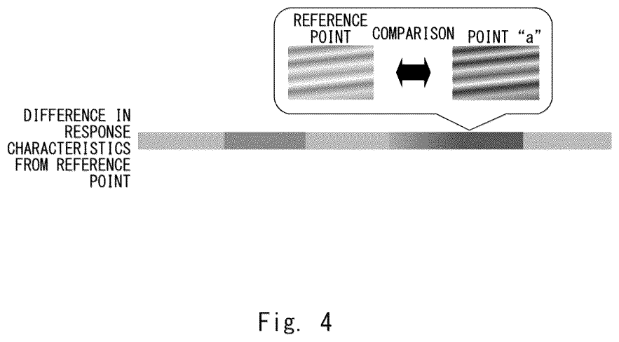

FIGS. 3 and 4 are diagrams for explaining a key point of the first example embodiment.

As described above, the measurement signal obtained by the measurement apparatus 20 is the spatiotemporal signal indicating the time-series change in the vibration intensity at each point on the submarine cable 30.

FIG. 3 is obtained by cutting out a measurement signal of an analysis target section from the measurement signal obtained by the measurement apparatus 20. The vibration illustrated in FIG. 3 indicates vibration caused by a wave. In FIG. 3, a horizontal axis represents time, and a vertical axis represents a distance of an optical fiber obtained from the measurement apparatus 20.

As illustrated in FIG. 3, the vibration caused by a wave is applied to each point on the submarine cable 30. Therefore, the response characteristics to the vibration are calculated for each point on the submarine cable 30 on the basis of the measurement signal. Here, as the response characteristics, physical parameters of the wave, specifically, at least one feature amount among feature amounts of a wave direction, a wave height, a wave speed, or a cycle of the wave are calculated.

For example, a wave height can be calculated from an amplitude value of the vibration caused by the wave. In addition, a wavelength can be calculated from a distance between points where time waveforms of the vibrations caused by the wave are in phase, and a wave speed can be calculated by dividing the wavelength by the cycle. In addition, the wave direction can be calculated from a delay time difference of the time waveform between the points.

FIG. 4 illustrates an example of a comparison processing.

In the example of FIG. 4, the response characteristics of a point “a” on the submarine cable 30 are compared with the response characteristics of a reference point. This comparison is made for each point on the submarine cable 30.

Here, the reference point for comparing the response characteristics may be selected for each point on the submarine cable 30, or a common position may be selected at each point on the submarine cable 30.

In addition, in a case where the reference point is selected for each point on the submarine cable 30, a point which has a close fiber space position, a point which has a close real space position, a point which has a similar laying mode of the submarine cable 30, or the like may be selected as the reference point. Here, the fiber space position is a position represented by a distance of the optical fiber from the measurement apparatus 20. On the other hand, the real space position is a position (xx, yy) with respect to the reference point, and is, for example, a position (xx, yy) represented by latitude and longitude.

In this way, for each point on the submarine cable 30, the response characteristics of the point are compared with the response characteristics of the reference point. Then, for example, it is estimated that an abnormality has occurred at a point where there is a difference from the response characteristics of the reference point, among the points on the submarine cable 30.

Next, a configuration of the first example embodiment will be described.

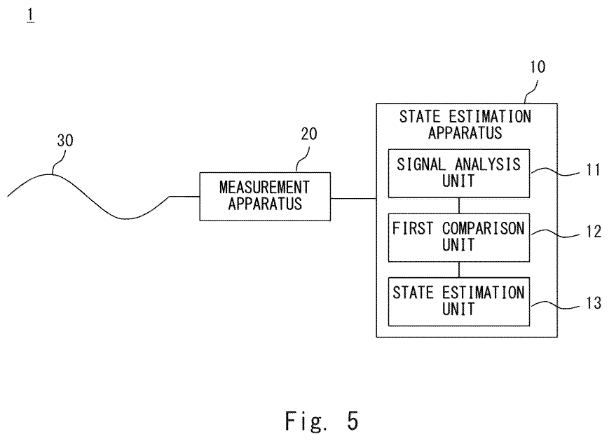

FIG. 5 is a diagram illustrating a configuration example of a state estimation system 1.

As illustrated in FIG. 5, the state estimation system 1 includes a state estimation apparatus 10 and the measurement apparatus 20. For example, the state estimation apparatus 10 and the measurement apparatus 20 are arranged inside an onshore facility 50, but the arrangement positions of the state estimation apparatus 10 and the measurement apparatus 20 are not limited thereto.

The submarine cable 30 is similar to that illustrated in FIG. 2, for example. That is, the submarine cable 30 is laid, for example, as illustrated in FIG. 2, and includes a power line and an optical fiber.

The measurement apparatus 20 measures the vibration applied to the submarine cable 30 and obtains the measurement signal by executing optical fiber sensing using the optical fiber included in the submarine cable 30. As described above, the measurement signal obtained by the measurement apparatus 20 is the spatiotemporal signal indicating the time-series change in the vibration intensity at each point on the submarine cable 30.

The state estimation apparatus 10 includes a signal analysis unit 11, a first comparison unit 12, and a state estimation unit 13.

The signal analysis unit 11 calculates, for each point on the submarine cable 30, the response characteristics to the vibration applied to the point on the basis of the measurement signal obtained by the measurement apparatus 20.

The first comparison unit 12 compares the response characteristics of each point on the submarine cable 30 with the response characteristics of the reference point, and obtains a comparison result as an inter-point comparison result (first comparison result).

The state estimation unit 13 estimates the state of the submarine cable 30 on the basis of the inter-point comparison result of each point on the submarine cable 30.

Next, components of the state estimation apparatus 10 will be described in detail.

### (1-1) Signal Analysis Unit 11

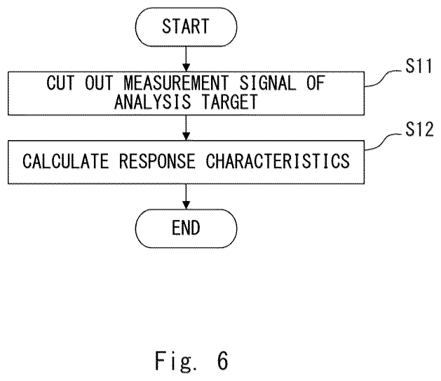

FIG. 6 is a flowchart for explaining an example of an operation flow of the signal analysis unit 11.

As illustrated in FIG. 6, first, the signal analysis unit 11 cuts out the measurement signal of the analysis target section from the measurement signal obtained by the measurement apparatus 20 (step S11).

Next, on the basis of the cut out measurement signal, the signal analysis unit 11 calculates, for each point on the submarine cable 30, the response characteristics to the vibration applied to the point (step S12).

At this time, the signal analysis unit 11 calculates, as the response characteristics, at least one among the feature amounts of the wave direction, the wave height, the wave speed, or the cycle of the wave.

In addition, the signal analysis unit 11 may execute band pass filtering on the cut out measurement signal in order to remove noise, and calculate the response characteristics on the basis of the measurement signal subjected to the band pass filtering.

Here, processing of step S12 will be described in detail.

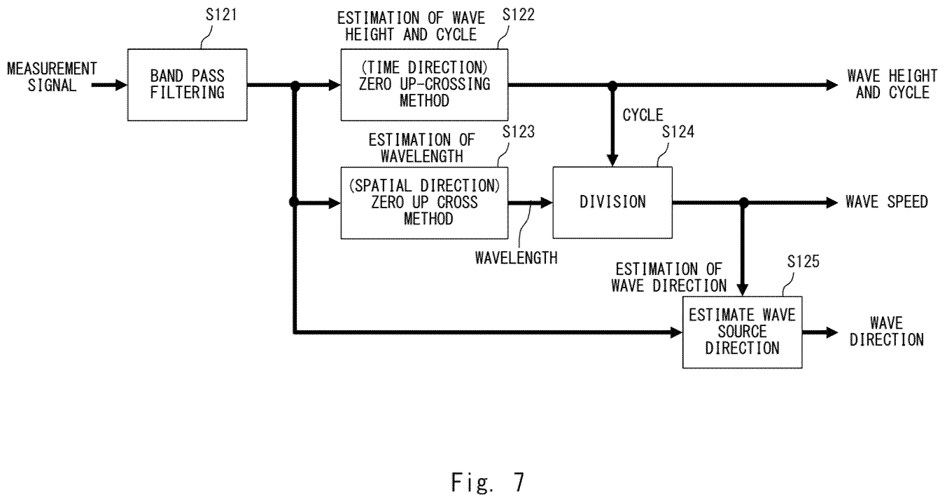

FIG. 7 is a flowchart for explaining an example of a processing flow in step S12 in FIG. 6.

As illustrated in FIG. 7, first, the signal analysis unit 11 executes the band pass filtering on the cut out measurement signal in order to remove noise (step S121).

Next, the signal analysis unit 11 applies a zero up-crossing method in a time direction to the time waveform obtained at a certain point, on the basis of the measurement signal subjected to the band pass filtering. As a result, the signal analysis unit 11 obtains the wave height and the cycle of the wave at that point (step S122). The signal analysis unit 11 performs this processing for each point on the submarine cable 30. As a method of obtaining the wave height and the cycle, a zero down-crossing method or the like can be used in addition to the zero up-crossing method.

Next, the signal analysis unit 11 applies the zero up-crossing method in a spatial direction to the vibration waveform obtained at a certain time, on the basis of the measurement signal subjected to the band pass filtering. As a result, the signal analysis unit 11 obtains the wavelength of the wave at that time (step S123).

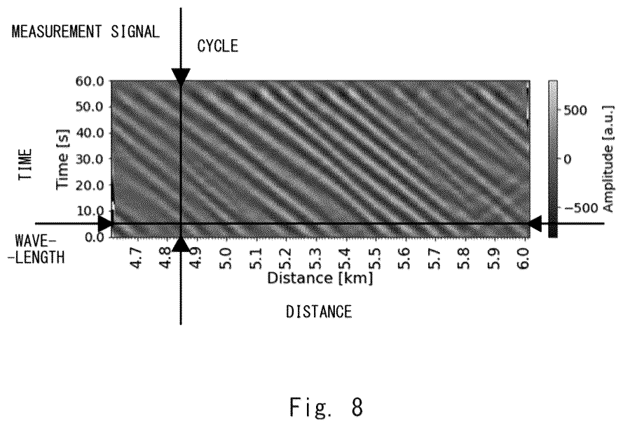

FIG. 8 is a diagram for explaining an example of processing in steps S122 and S123 in FIG. 7. FIG. 8 illustrates an example of the measurement signal subjected to the band pass filtering. In FIG. 8, a horizontal axis represents the distance of the optical fiber from the measurement apparatus 20, and a vertical axis represents time. In addition, shading in the drawing indicates a magnitude of the vibration intensity.

As illustrated in FIG. 8, in step S122, the signal analysis unit 11 obtains the wave height and cycle of the wave by applying the zero up-crossing method in the time direction (a vertical direction in the drawing). In addition, in step S123, the signal analysis unit 11 obtains the wavelength of the wave by applying the zero up-crossing method in the spatial direction (a horizontal direction in the drawing).

Next, the signal analysis unit 11 divides the wavelength of the wave obtained in step S123 by the cycle of the wave at the certain point obtained in step S122, to obtain the wave speed at that point (step S124). The signal analysis unit 11 performs this processing for each point on the submarine cable 30.

Thereafter, on the basis of the measurement signal subjected to the band pass filtering and the wave speed of the wave at the certain point obtained in step S124, the signal analysis unit 11 obtains the delay time difference of the time waveform between that point and another point to obtain a wave source direction, that is, the wave direction of the wave at that point (step S125). The signal analysis unit 11 performs this processing for each point on the submarine cable 30.

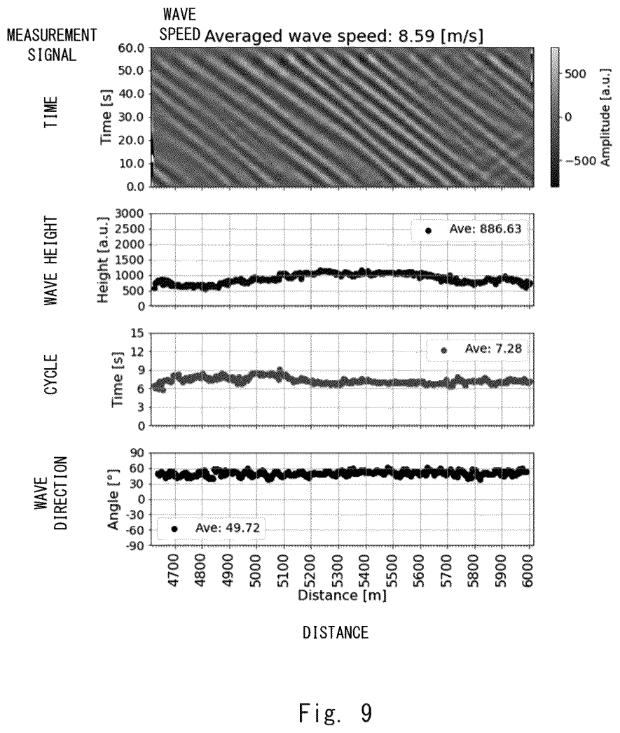

FIG. 9 is a diagram for explaining an example of the response characteristics calculated by the signal analysis unit 11.

FIG. 9 illustrates an example of the measurement signal, an example of the calculation result of the wave height, an example of the calculation result of the cycle, and an example of the calculation result of the wave direction in order from the top. A horizontal axis, a vertical axis, and shading in the uppermost drawing are similar to those in FIG. 8. In addition, in lower three drawings, a horizontal axis represents the distance of the optical fiber from the measurement apparatus 20, and a vertical axis represents a value of each feature amount.

Note that, in the case of calculating the feature amount using spatial information such as the wave height and the wave speed, the signal analysis unit 11 is not limited to calculating the value at each point in the analysis target section, and may calculate one value for the entire analysis target section.

In addition, in a case where a plurality of values are obtained for one feature amount, the signal analysis unit 11 may aggregate the plurality of values to obtain one value such as an average value, a maximum value, or a minimum value. Alternatively, the signal analysis unit 11 may obtain an average value of top ⅓ values of the plurality of values, similarly to a general method used for a significant wave height or the like.

In addition, in the case of calculating a plurality of feature amounts, the signal analysis unit 11 may create a feature amount vector by connecting the plurality of feature amounts.

In this way, the signal analysis unit 11 obtains the response characteristics that are a scalar or vector value for each point on the submarine cable 30.

### (1-2) First Comparison Unit 12

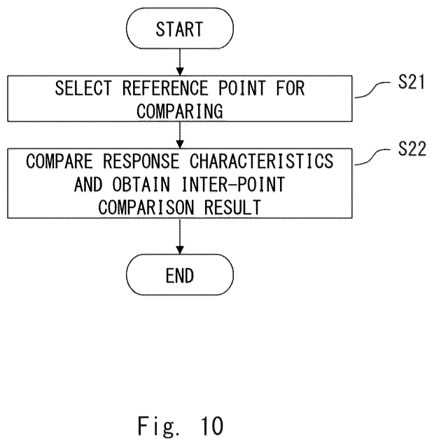

FIG. 10 is a flowchart for explaining an example of an operation flow of the first comparison unit 12. The first comparison unit 12 performs processing of FIG. 10 for each point on the submarine cable 30. Hereinafter, an example in which the first comparison unit 12 performs the processing of FIG. 10 for the point “a” on the submarine cable 30 will be described.

As illustrated in FIG. 10, first, the first comparison unit 12 selects a reference point for comparing the response characteristics with those of the point “a” (step S21).

At this time, the first comparison unit 12 can select an arbitrary reference point, and may select the reference point on the basis of a preset rule or may select the reference point on the basis of external information. For example, the first comparison unit 12 may select, as the reference point, a point which has a fiber space position close to that of the point “a”, a point which has a real space position close to that of the point “a”, or the like. In addition, in a case where the external information indicating the laying mode of each point on the submarine cable 30 is obtained, the first comparison unit 12 may select, as the reference point, a point which has a laying mode of the submarine cable 30 similar to that of the point “a”.

In addition, the first comparison unit 12 may select a plurality of reference points. For example, it is assumed that a feature amount vector including a plurality of feature amounts is obtained as the response characteristics for each of the plurality of reference points. In this case, the first comparison unit 12 may create a feature amount vector obtained by connecting the feature amount vectors obtained for the plurality of reference points, and compare the feature amount vector with the response characteristics of the point “a” in step S22 described later. Alternatively, the first comparison unit 12 may obtain an aggregation result such as an average value for each of the feature amounts constituting the feature amount vector obtained for each of the plurality of reference points, create a feature amount vector by recombining the aggregation results, and compare the feature amount vector with the response characteristics of the point “a” in step S22 described later.

Note that the reference point is not limited to being selected by the first comparison unit 12, and may be manually selected by a user on the basis of a preset rule.

Next, the first comparison unit 12 compares the response characteristics of the point “a” with the response characteristics of the reference point, and obtains a comparison result as the inter-point comparison result (step S22).

At this time, the first comparison unit 12 may calculate a similarity between the feature amounts calculated as the response characteristics and obtain a calculation result as the inter-point comparison result. In addition, the first comparison unit 12 may calculate the similarity between the feature amounts by using cross-correlation, a correlation coefficient, an inner product, a cosine of an angle formed, a covariance, a Euclidean distance, a Mahalanobis distance, cosine similarity, or the like.

In addition, in a case where the feature amount vector including the plurality of feature amounts is calculated as the response characteristics, the first comparison unit 12 may calculate the similarity between the feature amounts for each feature amount, and may set, as the inter-point comparison result, an aggregation result obtained by aggregating the calculation results by a weighted sum. In addition, in this case, the first comparison unit 12 may change a similarity calculation method for each feature amount.

The processing of FIG. 10 described above is performed for each point on the submarine cable 30 as described above.

In this way, the first comparison unit 12 obtains the inter-point comparison result that is a scalar or vector value for each point on the submarine cable 30.

### (1-3) State Estimation Unit 13

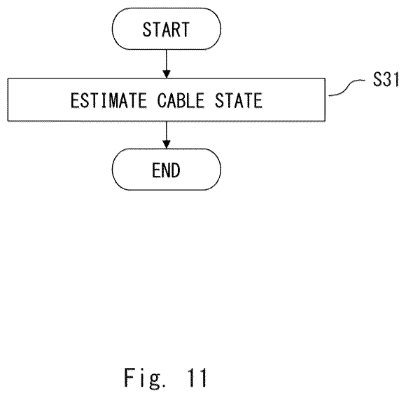

FIG. 11 is a flowchart for explaining an example of an operation flow of the state estimation unit 13.

As illustrated in FIG. 11, the state estimation unit 13 estimates the state of the submarine cable 30 on the basis of the inter-point comparison result of each point on the submarine cable 30 (step S31).

At this time, the inter-point comparison result of each point on the submarine cable 30 is a scalar or vector value. Therefore, the state estimation unit 13 may compare the inter-point comparison result of each point on the submarine cable 30 with a preset threshold (first threshold) and estimate that an abnormality has occurred at a point where the inter-point comparison result exceeds the threshold.

Examples of the abnormal state include a change in the buried depth of the submarine cable 30, a change in the orientation of the submarine cable 30, breakage of the protective tube of the submarine cable 30, and an increase in the exposed section of the submarine cable 30.

As described above, according to the first example embodiment, on the basis of the measurement signal which is obtained by the measurement apparatus 20 by executing the optical fiber sensing using the optical fiber included in the submarine cable 30, the signal analysis unit 11 calculates, for each point on the submarine cable 30, the response characteristics to the vibration applied to that point. The first comparison unit 12 compares the response characteristics of each point on the submarine cable 30 with the response characteristics of the reference point, and obtains a comparison result as the inter-point comparison result. The state estimation unit 13 estimates the state of the submarine cable 30 on the basis of the inter-point comparison result of each point on the submarine cable 30.

As a result, for example, it is possible to estimate that an abnormality has occurred at a point where there is a difference from the response characteristics of the reference point, among the points on the submarine cable 30. In addition, in this estimation, the response characteristics are compared with the response characteristics of the reference point, so that the abnormality data at time there is an abnormality is unnecessary. Therefore, it is possible to estimate the state of the submarine cable 30 without preparing abnormality data in advance.

### Second Example Embodiment

First, a key point of a second example embodiment will be described.

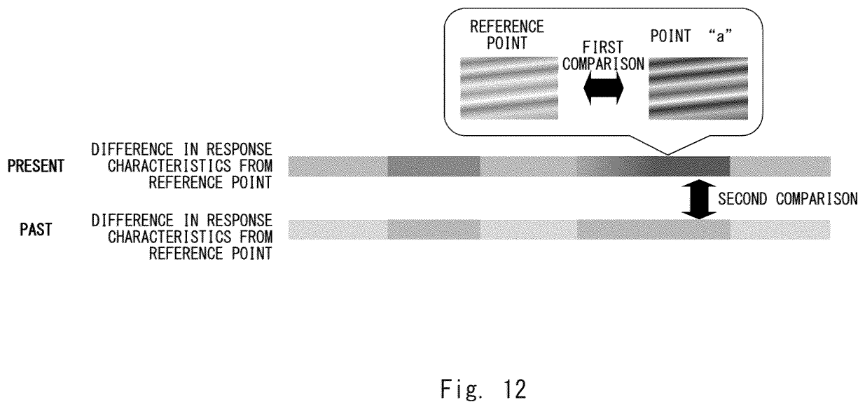

FIG. 12 is a diagram for explaining a key point of the second example embodiment.

FIG. 12 illustrates an example of the comparison processing.

As illustrated in FIG. 12, in the first example embodiment described above, for each point on the submarine cable 30, comparison (first comparison) between the response characteristics of the point and the response characteristics of the reference point is performed to obtain the inter-point comparison result. That is, in the first example embodiment described above, only one-stage comparison is performed.

On the other hand, in the second example embodiment, two-stage comparison is performed. That is, after the above-described first comparison is performed for each point on the submarine cable 30, comparison (second comparison) between the inter-point comparison result at present and the inter-point comparison result in the past of the point is performed.

Here, as the past for comparing the inter-point comparison result, a past time point before a preset period (for example, one month ago, one year ago, or the like) may be selected, or a past time point having similar external environmental conditions (weather, an operation status of the offshore facility 60, or the like) may be selected.

In this way, for each point on the submarine cable 30, the inter-point comparison result at present of that point is compared with the inter-point comparison result in the past. Then, for example, it is estimated that an abnormality has occurred at a point where there is a difference from the response characteristics of the reference point or a point where there is a difference from the inter-point comparison result in the past, among the points on the submarine cable 30.

Next, a configuration of the second example embodiment will be described.

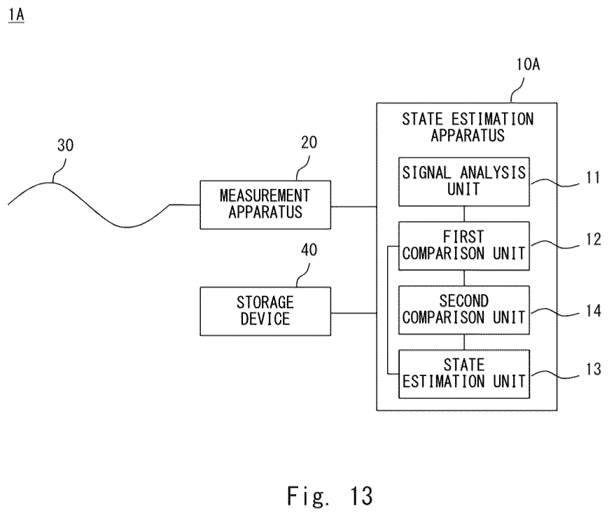

FIG. 13 is a diagram illustrating a configuration example of a state estimation system 1A.

As illustrated in FIG. 13, the state estimation system 1A is different from the state estimation system 1 in that the state estimation apparatus 10 is replaced with a state estimation apparatus 10A and a storage device 40 is added. The state estimation apparatus 10A is different from the state estimation apparatus 10 in that a second comparison unit 14 is added.

The storage device 40 stores the inter-point comparison result of each point on the submarine cable 30 obtained by the first comparison unit 12.

For each point on the submarine cable 30, the second comparison unit 14 compares the inter-point comparison result at present and the inter-point comparison result in the past for that point, and obtains a comparison result as a past comparison result (second comparison result).

The state estimation unit 13 estimates the state of the submarine cable 30 on the basis of the inter-point comparison result or the past comparison result of each point on the submarine cable 30.

Next, components of the state estimation apparatus 10A will be described in detail. Hereinafter, only components having operations different from those in the first example embodiment and newly added components will be described.

### (2-1) First Comparison Unit 12

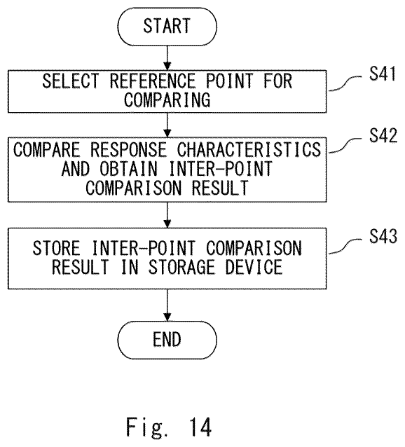

FIG. 14 is a flowchart for explaining an example of the operation flow of the first comparison unit 12.

As illustrated in FIG. 14, first, the first comparison unit 12 performs processing of steps S41 and S42 similar to steps S21 and S22 of FIG. 10 described above for each point on the submarine cable 30, and obtains an inter-point comparison result.

Thereafter, the first comparison unit 12 stores the inter-point comparison result of each point on the submarine cable 30 in the storage device 40 (step S43).

### (2-2) Second Comparison Unit 14

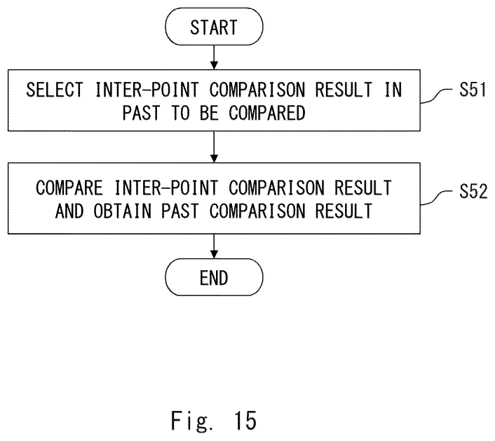

FIG. 15 is a flowchart for explaining an example of an operation flow of the second comparison unit 14. The second comparison unit 14 performs processing of FIG. 15 for each point on the submarine cable 30. Hereinafter, an example in which the second comparison unit 14 performs the processing of FIG. 15 for the point “a” on the submarine cable 30 will be described.

As illustrated in FIG. 15, first, the second comparison unit 14 selects the inter-point comparison result in the past to be compared with the inter-point comparison result at present of the point “a” (step S51).

At this time, the second comparison unit 14 can select the inter-point comparison result at an arbitrary past time point. For example, the second comparison unit 14 may select the inter-point comparison result of a time point before a preset period (for example, one month ago, one year ago, or the like) or may select the inter-point comparison result at a past time point having similar external environmental conditions (weather, the operation status of the offshore facility 60, or the like).

Note that the inter-point comparison result in the past is not limited to being selected by the second comparison unit 14, and may be manually selected by the user on the basis of a preset rule.

Next, the second comparison unit 14 compares the inter-point comparison result at present of the point “a” and the inter-point comparison result in the past of the point “a”, and obtains a comparison result as the past comparison result (step S52).

At this time, it is sufficient if the second comparison unit 14 acquires the inter-point comparison result in the past from the storage device 40. In addition, the second comparison unit 14 may acquire the inter-point comparison result at present from the storage device 40 or from the first comparison unit 12.

In addition, the second comparison unit 14 may calculate a similarity between the inter-point comparison results that are scalar or vector values, and obtain a calculation result as the past comparison result. In addition, the second comparison unit 14 may calculate the similarity by a method similar to that of the first comparison unit 12, or may calculate the similarity by a method different from that of the first comparison unit 12.

The processing of FIG. 15 described above is performed for each point on the submarine cable 30 as described above.

In this way, the second comparison unit 14 obtains the past comparison result that is a scalar or vector value for each point on the submarine cable 30.

### (2-3) State Estimation Unit 13

The state estimation unit 13 estimates the state of the submarine cable 30 on the basis of the inter-point comparison result or the past comparison result of each point on the submarine cable 30.

At this time, the past comparison result of each point on the submarine cable 30 is a scalar or vector value. Therefore, in the case of estimating the state of the submarine cable 30 on the basis of the past comparison result of each point on the submarine cable 30, the state estimation unit 13 may compare the past comparison result of each point on the submarine cable 30 with a preset threshold (second threshold) and estimate that an abnormality has occurred at a point where the past comparison result exceeds the threshold.

Note that an operation in the state estimation unit 13 in the case of estimating the state of the submarine cable 30 on the basis of the inter-point comparison result of each point on the submarine cable 30 is similar to that of the first example embodiment described above, and thus the description thereof will be omitted.

In addition, an example of the operation flow of the state estimation unit 13 is also similar to that in FIG. 11 of the first example embodiment described above, and thus the description thereof will be omitted.

In addition, an example of the abnormal state occurring in the submarine cable 30 is similar to the abnormal state described in the first example embodiment described above, and thus description thereof is omitted.

As described above, according to the second example embodiment, for each point on the submarine cable 30, the second comparison unit 14 compares the inter-point comparison result at present and the inter-point comparison result in the past for that point, and obtains the comparison result as the past comparison result. The state estimation unit 13 estimates the state of the submarine cable 30 on the basis of the inter-point comparison result or the past comparison result of each point on the submarine cable 30.

As a result, for example, it is possible to estimate that an abnormality has occurred at a point where there is a difference from the inter-point comparison result in the past, among the points on the submarine cable 30.

The other effects are similar to the effects according to the first example embodiment described above.

### <Hardware Configuration of State Estimation Apparatus>

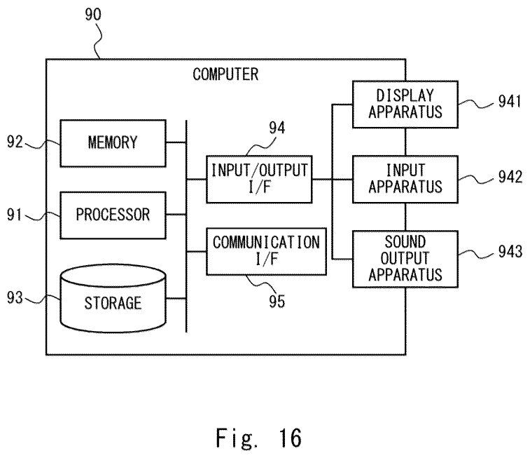

FIG. 16 is a block diagram illustrating a schematic hardware configuration example of a computer 90 that implements the state estimation apparatuses 10 and 10A.

As illustrated in FIG. 16, the computer 90 includes a processor 91, a memory 92, a storage 93, an input/output interface (input/output I/F) 94, a communication interface (communication I/F) 95, and the like. The processor 91, the memory 92, the storage 93, the input/output interface 94, and the communication interface 95 are connected to each other by a data transmission line for transmitting and receiving data.

The processor 91 is, for example, an arithmetic processing apparatus such as a central processing unit (CPU) or a graphics processing unit (GPU). The memory 92 is, for example, a memory such as a random access memory (RAM) or a read only memory (ROM). The storage 93 is, for example, a storage device such as a hard disk drive (HDD), a solid state drive (SSD), or a memory card. Furthermore, the storage 93 may be a memory such as a RAM or a ROM.

A program is stored in the storage 93. This program includes a group of commands (or software code) for causing the computer 90 to perform one or more functions in the above-described state estimation apparatuses 10 and 10A in a case where being read by the computer. The components in the above-described state estimation apparatuses 10 and 10A may be implemented by the processor 91 reading and executing a program stored in the storage 93. In addition, a storage function in the above-described state estimation apparatuses 10 and 10A may be realized by the memory 92 or the storage 93.

Further, the above-described program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The input/output interface 94 is connected to a display apparatus 941, an input apparatus 942, a sound output apparatus 943, and the like. The display apparatus 941 is an apparatus that displays a screen corresponding to depiction data processed by the processor 91, such as a liquid crystal display (LCD), a cathode ray tube (CRT) display, or a monitor. The input apparatus 942 is an apparatus that receives an operation input of an operator, and is, for example, a keyboard, a mouse, a touch sensor, or the like. The display apparatus 941 and the input apparatus 942 may be integrated, and may be implemented as a touch panel. The sound output apparatus 943 is an apparatus that acoustically outputs a sound that corresponds to acoustic data processed by the processor 91, such as a speaker.

The communication interface 95 transmits or receives data to and from an external apparatus. For example, the communication interface 95 communicates with an external apparatus via a wired communication path or a wireless communication path.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Further, each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Further, the whole or part of the example embodiments disclosed above can be described as, but not limited to, the following supplementary notes.

### (Supplementary Note 1)

A state estimation apparatus including:
at least one memory configured to store a group of commands; and
at least one processor configured to execute the group of commands to
   calculate, for each point on a submarine cable, response characteristics to vibration applied to that point on the basis of a measurement signal obtained by a measurement apparatus by executing optical fiber sensing using an optical fiber included in the submarine cable,
   compare, for each point on the submarine cable, the response characteristics of that point with the response characteristics of a reference point, and obtain a result of the comparison as a first comparison result, and
   estimate a state of the submarine cable on the basis of the first comparison result of each point on the submarine cable.

### (Supplementary Note 2)

The state estimation apparatus according to Supplementary Note 1,
in which the at least one processor is configured to
compare, for each point on the submarine cable, the first comparison result at present of that point and the first comparison result in a past of that point, and obtain a result of the comparison as a second comparison result, and
estimate a state of the submarine cable on the basis of the first comparison result or the second comparison result of each point on the submarine cable.

### (Supplementary Note 3)

The state estimation apparatus according to Supplementary Note 2, in which
the vibration is vibration caused by a wave, and
the at least one processor is configured to calculate, as the response characteristics, at least one feature amount among feature amounts of a wave direction, a wave height, a wave speed, and a cycle of a wave.

### (Supplementary Note 4)

The state estimation apparatus according to Supplementary Note 3,
in which the at least one processor is further configured to
calculate, for each point on the submarine cable, a similarity between the feature amount of that point and the feature amount of the reference point, and obtain a result of the calculation as the first comparison result, and
calculate, for each point on the submarine cable, a similarity between the first comparison result at present of that point and the first comparison result in the past of that point, and obtains a result the calculation as the second comparison result.

### (Supplementary Note 5)

The state estimation apparatus according to Supplementary Note 2,
in which the at least one processor is configured to
in a case where a state of the submarine cable is estimated on the basis of the first comparison result of each point on the submarine cable, compare the first comparison result of each point on the submarine cable with a first threshold, and estimate that an abnormality has occurred at a point where the first comparison result exceeds the first threshold, and
in a case where a state of the submarine cable is estimated on the basis of the second comparison result of each point on the submarine cable, compare the second comparison result of each point on the submarine cable with a second threshold, and estimate that an abnormality has occurred at a point where the second comparison result exceeds the second threshold.

### (Supplementary Note 6)

A state estimation system including:
the measurement apparatus configured to obtain the measurement signal by executing optical fiber sensing using an optical fiber included in the submarine cable;
the state estimation apparatus according to supplementary note 2; and
a storage device configured to store the first comparison result of each point on the submarine cable,
in which the at least one processor is configured to obtain the first comparison result in a past of each point on the submarine cable from the storage device.

### (Supplementary Note 7)

A state estimation method executed by a state estimation apparatus, including:
a signal analysis step of calculating, for each point on a submarine cable, response characteristics to vibration applied to that point on the basis of a measurement signal obtained by a measurement apparatus by executing optical fiber sensing using an optical fiber included in the submarine cable;
a first comparison step of comparing, for each point on the submarine cable, the response characteristics of that point with the response characteristics of a reference point, and obtaining a result of the comparison as a first comparison result; and
a state estimation step of estimating a state of the submarine cable on the basis of the first comparison result of each point on the submarine cable.

### (Supplementary Note 8)

The state estimation method according to Supplementary Note 7, further including a second comparison step of comparing, for each point on the submarine cable, the first comparison result at present of that point and the first comparison result in the past of that point, and obtain a result of the comparison as a second comparison result,
in which in the state estimation step, a state of the submarine cable is estimated on the basis of the first comparison result or the second comparison result of each point on the submarine cable.

### (Supplementary Note 9)

A non-transitory computer readable medium having stored thereon a program
causing a computer to execute:
a signal analysis procedure of calculating, for each point on a submarine cable, response characteristics to vibration applied to that point on the basis of a measurement signal obtained by a measurement apparatus by executing optical fiber sensing using an optical fiber included in the submarine cable;
a first comparison procedure of comparing, for each point on the submarine cable, the response characteristics of that point with the response characteristics of a reference point, and obtaining a result of the comparison as a first comparison result; and
a state estimation procedure of estimating a state of the submarine cable on the basis of the first comparison result of each point on the submarine cable.

### (Supplementary Note 10)

The non-transitory computer readable medium according to Supplementary Note 9, in which
the program causes the computer to further execute a second comparison procedure of comparing, for each point on the submarine cable, the first comparison result at present of that point and the first comparison result in the past of that point and obtaining a result of the comparison as a second comparison result, and
in the state estimation procedure, a state of the submarine cable is estimated on the basis of the first comparison result or the second comparison result of each point on the submarine cable.

Note that, some or all of elements (e.g., structures and functions) specified in Supplementary Notes 2 to 5 dependent on Supplementary Note 1 may also be dependent on Supplementary Notes 7 and 9 in dependency similar to that of Supplementary Notes 2 to 5 dependent on Supplementary Note 1. Some or all of elements specified in any of Supplementary Notes may be applied to various types of hardware, software, and recording means for recording software, systems, and methods.

What is claimed is:

1. A state estimation apparatus comprising:
at least one memory configured to store a group of commands; and
at least one processor configured to execute the group of commands to
calculate, for each point on a submarine cable, response characteristics to vibration applied to that point on a basis of a measurement signal obtained by a measurement apparatus by executing optical fiber sensing using an optical fiber included in the submarine cable,
compare, for each point on the submarine cable, the response characteristics of that point with the response characteristics of a reference point, and obtain a result of the comparison as a first comparison result, and
estimate a state of the submarine cable on a basis of the first comparison result of each point on the submarine cable.

2. The state estimation apparatus according to claim 1,
wherein the at least one processor is configured to
compare, for each point on the submarine cable, the first comparison result at present of that point and the first comparison result in a past of that point, and obtain a result of the comparison as a second comparison result, and
estimate a state of the submarine cable on a basis of the first comparison result or the second comparison result of each point on the submarine cable.

3. The state estimation apparatus according to claim 2, wherein
the vibration is vibration caused by a wave, and
the at least one processor is configured to calculate, as the response characteristics, at least one feature amount among feature amounts of a wave direction, a wave height, a wave speed, and a cycle of a wave.

4. The state estimation apparatus according to claim 3,
wherein the at least one processor is further configured to calculate, for each point on the submarine cable, a similarity between the feature amount of that point and the feature amount of the reference point, and obtain a result of the calculation as the first comparison result, and
calculate, for each point on the submarine cable, a similarity between the first comparison result at present of that point and the first comparison result in the past of that point, and obtains a result the calculation as the second comparison result.

5. The state estimation apparatus according to claim 2,
wherein the at least one processor is configured to
in a case where a state of the submarine cable is estimated on a basis of the first comparison result of each point on the submarine cable, compare the first comparison result of each point on the submarine cable with a first threshold, and estimate that an abnormality has occurred at a point where the first comparison result exceeds the first threshold, and
in a case where a state of the submarine cable is estimated on a basis of the second comparison result of each point on the submarine cable, compare the second comparison result of each point on the submarine cable with a second threshold, and estimate that an abnormality has occurred at a point where the second comparison result exceeds the second threshold.

6. A state estimation method executed by a state estimation apparatus, comprising:
a signal analysis step of calculating, for each point on a submarine cable, response characteristics to vibration applied to that point on a basis of a measurement signal obtained by a measurement apparatus by executing optical fiber sensing using an optical fiber included in the submarine cable;
a first comparison step of comparing, for each point on the submarine cable, the response characteristics of that point with the response characteristics of a reference point, and obtaining a result of the comparison as a first comparison result; and
a state estimation step of estimating a state of the submarine cable on a basis of the first comparison result of each point on the submarine cable.

7. The state estimation method according to claim 6, further comprising a second comparison step of comparing, for each point on the submarine cable, the first comparison result at present of that point and the first comparison result in a past of that point, and obtain a result of the comparison as a second comparison result,
wherein in the state estimation step, a state of the submarine cable is estimated on a basis of the first comparison result or the second comparison result of each point on the submarine cable.

8. A non-transitory computer readable medium having stored thereon a program
causing a computer to execute:
a signal analysis procedure of calculating, for each point on a submarine cable, response characteristics to vibration applied to that point on a basis of a measurement signal obtained by a measurement apparatus by executing optical fiber sensing using an optical fiber included in the submarine cable;
a first comparison procedure of comparing, for each point on the submarine cable, the response characteristics of that point with the response characteristics of a reference point, and obtaining a result of the comparison as a first comparison result; and
a state estimation procedure of estimating a state of the submarine cable on a basis of the first comparison result of each point on the submarine cable.

9. The non-transitory computer readable medium according to claim 8, wherein
the program causes the computer to further execute a second comparison procedure of comparing, for each point on the submarine cable, the first comparison result at present of that point and the first comparison result in a past of that point and obtaining a result of the comparison as a second comparison result, and
in the state estimation procedure, a state of the submarine cable is estimated on a basis of the first comparison result or the second comparison result of each point on the submarine cable.
